(19) United States
(12) Patent Application Publication
(10) Pub. No.: US 2019/0080308 A1
(43) Pub. Date: Mar. 14, 2019

(54) OPEN ECONOMIC FRAMEWORK AND A METHOD OF OPERATION

(71) Applicant: UVUE Ltd., Cambridge (GB)

(72) Inventors: Humayun Munir Sheikh, Cambridge (GB); Toby William Simpson, Cambridge (GB)

(21) Appl. No.: 16/130,188

(22) Filed: Sep. 13, 2018

Related U.S. Application Data
(60) Provisional application No. 62/557,836, filed on Sep. 13, 2017.

(51) Int. Cl. G06Q 20/22; G06Q 30/06; G06Q 30/08; H04L 9/06; H04L 9/32

(52) U.S. Cl. CPC G06Q 20/223; G06Q 30/0609; G06Q 30/08; H04L 2209/38; H04L 9/3236; H04L 2209/56; H04L 9/0618

(57) ABSTRACT

Disclosed is a system of providing a service to user, including a first autonomous economic agent, a plurality of second autonomous economic agent and an open economic ledger. The first autonomous economic agent associated with user is configured to generate and broadcast service request, receive plurality of service bids from second autonomous economic agent associated with a service provider, select at least one second autonomous economic agent based on a preference associated with the service request and a confidence factor. The second autonomous economic agent is configured to execute a smart contract with the first autonomous economic agent and enable at least one service component of the service provider associated with selected second autonomous economic agent to provide service to user. The open economic ledger is configured to record one or more transaction events between first autonomous economic agent and plurality of second autonomous economic agents.

### TECHNICAL FIELD

The present disclosure relates to systems that provide services in an autonomously manner by accessing an open economic framework (OEF) implemented on a decentralized computing network, for example a peer-to-peer network; beneficially, a technical operation of the decentralized computing network is modified adaptively in response to operations being executed in the open economic framework (OEF) to increase its robustness to hostile third-party attacks, by adaptive and selective use of data encryption, data obfuscation, and temporal data decoys. Moreover, the present disclosure relates to methods for (of) providing services autonomously by accessing the open economic framework (OEF) implemented on the aforesaid decentralized computing network. Furthermore, the methods are relevant, for example, to service industries employ the open economic framework (OEF), wherein the services include, for example, technical resources, technical materials, technical components, and similar; beneficially, the methods include modifying adaptively a technical operation of the decentralized computing network in response to operations being executed in the open economic framework (OEF) to increase its robustness to hostile third-party attacks, by adaptive and selective use of data encryption, data obfuscation, and temporal data decoys. The present disclosure is concerned with a technical manner of operation of the decentralized computing network and how data is processed with the network, to make the decentralized computing network more robust to third-party hostile attack.

### BACKGROUND

Novel types of data communication networks have been the subject matter of numerous granted patents over a period of many years. More efficient ways of operating such novel data networks that render the data networks more robust and more efficient are highly desirable technical effects. Various approaches to providing data encryption and corresponding data decryption in data networks has been the subject matter of numerous granted patents.

By using contemporary technology, human beings are better able to cope with handling tasks at a temporally faster rate, and with greater ease. Recently, human beings rely more on technology for executing most of their tasks, namely for executing their “jobs”. Additionally, jobs like cleaning, cooking and communicating are contemporarily executed with help from machines, and robotic systems in future are anticipated to assist with such jobs to a greater extent. Consequently, in many parts of the world, service industries have grown remarkably in recent years by utilizing more modern technologies, for example by using the Internet®, artificial intelligence (AI), cybernetics and so forth. Moreover, a combination of human labour (US English: “labor”) and technology has resulted in an improved lifestyle for many human beings. Recently, a concept of “improved life style” is realized by way of services provided by service providers, because people are so busy with their daily schedules that they are not able to execute their own tasks, namely “jobs” alone. However, often such tasks are crucial and need to be executed properly and in a timely manner. Conventionally, people, namely “consumers/users”, acquire services by looking for service providers and hiring helpers using different arrangements for exchange of smart contractual consideration (for example, financial payment for providing a service, but not limited thereto). However, these service providers exist in very limited numbers, thereby providing very few alternatives from which to choose. Moreover, such limited options of service providers deprive consumers from receiving a satisfactory service at a genuine price. For example, the genuine price is associated with providing the service as a first consideration and receiving second consideration in return, wherein the first and second considerations are of mutually substantially similar magnitude. In addition, a reliability of a given service provider also becomes a concern as the given service provider has an associated credibility that is potentially not known to consumers. Furthermore, known contemporary processes of acquiring a service often consumes a lot of human intervention and time for making different decisions, for example a mode of payment, a time of service delivery and a spatial location of delivery, and many more involved with it.

Generally, a job at hand gets serviced in a “first-come first-served” manner, disregarding its urgency, making such delivery of such a service inconvenient for the consumers or alternatively, priced at a premium due to its perceived urgency. Specifically, services are not always available at a current spatial location of the client causing him/her to settle for a less promising (namely sub-optimal) local service provider. Consequently, a given service provider's commitment towards a given job at hand is always under question and an associated client potentially suffers loss if the job does not get done as planned.

Networks that enable services to be ordered and services to be delivered become relied upon, such that technical disruption of the networks potentially has considerable economic and societal impact. Thus, a robustness of network supporting such order and delivery of services is a primary technical concern. Moreover, critical points of failure of the networks is also a technical concern, because malicious third parties trying to disrupt operation of the networks will try to exploit weak point (“critical point of failure”) of the networks, or portions of the networks that convey particularly large amounts of consideration. Whereas, a given network can be made robust through the use of encryption, for example public-private key encryption, the use of heavy degrees of encryption through a network support ordering and supply of services potentially renders the given network unwieldy and inefficient in operation, especially when the given network is being progressively evolve over time as new service ordering techniques and new service delivery arrangements are implemented via the given network.

Therefore, in light of the foregoing technical problems associated with conventional supply of services, there exists a need to overcome the aforementioned problems associated with providing a given service to a user of the given service.

### SUMMARY

The present disclosure seeks to provide an improved method of (for) providing a service to a user in an open economic framework (OEF) implemented on a decentralised computing network, for example a peer-to-peer network.

The present disclosure also seeks to provide an improved system implemented on a decentralised computing network, for providing a service to a user via an open economic framework (OEF).

According to a first aspect, an embodiment of the present disclosure provides a system that provides, when in operation, services autonomously via an open economic framework (OEF) implemented on a decentralized computing network, characterised in that the system comprises:
a first autonomous economic agent associated with a user equipment coupled to the computing network that generates and broadcasts, when in operation, a service request, wherein the first autonomous economic agent receives instruction for generating the service request from a user using the user equipment;
a plurality of second autonomous economic agents hosted within the open economic framework associated with a plurality of service providers, wherein each of the service providers comprises at least one service component, wherein the plurality of second autonomous economic agents provides, when in operation, the first autonomous economic agent with a plurality of service bids via the open economic framework in response to the generated service request; and
an open economic ledger linked to the first autonomous economic agent and the plurality of second autonomous economic agents, wherein the open economic ledger when in operation, records one or more transaction events between the first autonomous economic agent and the plurality of second autonomous economic agents,

wherein the first autonomous economic agent when in operation, selects at least one of the second autonomous economic agents based on the preferences associated with the service request and a confidence factor of the least one of the second autonomous economic agents, and wherein the at least one selected second autonomous economic agent, when in operation, performs an execution of a smart contract with the first autonomous economic agent for providing the service autonomously, and wherein the execution of the smart contract is subject to a degree of data protection implemented via the decentralized computing network that is adaptively adjusted depending upon one or more parameters of the smart contract.

The invention is of advantage in the structuring the decentralized communication network, with an adaptive degree of data protection, to function in a manner to host the open economic forum and economic agents and allow various types of data exchange to occur therebetween results in services being provided more efficiently and effectively via the decentralized communication network.

Optionally, when implementing the degree of data protection, the first autonomous economic agent and the plurality of second autonomous economic agents encrypt the one or more transaction events by employing intelligent algorithms to secure the open economic framework, wherein the intelligent algorithms include adaptive data encryption and data obfuscation processing operations.

More optionally, when the decentralized computing network is in operation, the adaptive data encryption and data obfuscation processing operations are selected depending upon at least one of: a temporal rate of execution of smart contracts via a given node of the decentralized computing network, considerations associated with smart contracts being executed via a given node of the decentralized computing network.

More optionally, the adaptive data encryption and data obfuscation processing operations employ a combination of following data protection processes: encryption, decryption, data obfuscation by swapping one or more bits of data bytes, addition of obfuscating redundant data (namely, “data decoys”), temporally randomized transmission times for data within the decentralized computing network.

Optionally, the selected second autonomous economic agent receives a feedback from the user, wherein the feedback is used to update the confidence factor of the selected autonomous economic agent on the open economic ledger.

Optionally, the confidence factor includes at least one of: historical information of services provided using the second autonomous economic agent; and number of services provided using the second autonomous economic agent.

Optionally, the plurality of second autonomous economic agents includes a first set of second autonomous economic agents and a second set of second autonomous economic agents, wherein the first set of second autonomous economic agents and the second set of second autonomous economic agents, when in operation, generates a collaborative service bid in response to the generated service request.

Optionally, the first set of second autonomous economic agents when in operation, executes at least a portion of the service, and wherein the second set of second autonomous economic agents, when in operation, executes the remaining portion of the service.

Optionally, the one or more transaction event corresponds to the exchange of data between the plurality of autonomous, wherein the data includes: the confidence factor of one or more autonomous economic agent; information associated with remuneration; service request; service bid; and smart contract.

Optionally, the preferences associated with the service request include at least one of: a timeframe needed for completion of the service; a cost associated with the service; a quality associated with the service; at least one customised instruction associated with the service.

Optionally, the smart contract includes a plurality of parameters associated with the selected service bid for providing the service.

Optionally, the plurality of parameters associated with the selected service bid includes at least one of a timeframe needed for completion of the service; a cost associated with the service; a quality associated with the service; at least one customised instruction associated with the service.

According to a second aspect, an embodiment of the present disclosure provides a method for (of) providing services autonomously using an open economic framework implemented on a decentralized computing network, characterised in that the method comprises:
generating and broadcasting a service request upon receiving instruction for generating the service request from a user, wherein a user equipment is coupled to the computing network for generating and broadcasting the service request when in operation,
providing a plurality of service bids by a plurality of second autonomous economic agents in response to the generated service request via the open economic framework, wherein the plurality of second autonomous economic agents is hosted within the open economic framework
recording one or more transaction events between the first autonomous economic agent and the plurality of second autonomous economic agents,
selecting at least one of second autonomous economic agent based on preferences associated with the service request and a confidence factor associated with the plurality of the second autonomous economic agents, wherein the confidence factor is acquired by the first autonomous economic agent from the open economic ledger, wherein the plurality of second autonomous economic agents associated with a plurality of service providers, wherein each of the service providers comprise at least one service component,
performing an execution of a smart contract between the at least one selected second autonomous economic agent and the first autonomous economic agent, wherein the execution of the smart contract is subject to a degree of data protection implemented via the decentralized computing network that is adaptively adjusted depending upon one or more parameters of the smart contract, and
enabling at least one service component of the service provider associated with the selected second autonomous economic agent to provide the service to the user.

Optionally, when implementing the degree of data protection, the first autonomous economic agent and the plurality of second autonomous economic agents encrypt the one or more transaction events by employing intelligent algorithms to secure the open economic framework, wherein the intelligent algorithms include adaptive data encryption and data obfuscation processing operations.

More optionally, when the decentralized computing network is in operation, the adaptive data encryption and data obfuscation processing operations are selected depending upon at least one of: a temporal rate of execution of smart contracts via a given node of the decentralized computing network, considerations associated with smart contracts being executed via a given node of the decentralized computing network.

More optionally, the adaptive data encryption and data obfuscation processing operations employ a combination of following data protection processes: encryption, decryption, data obfuscation by swapping one or more bits of data bytes, addition of obfuscating redundant data (namely, “data decoys”), temporally randomized transmission times for data within the decentralized computing network.

According to a third aspect, an embodiment of the present disclosure provides a computer program product for providing services autonomously using an open economic framework implemented on a decentralized computing network, the computer program product comprising a non-transitory machine-readable data storage medium having stored thereon program instructions that, when accessed by a processing device, cause the processing device to:
generate and broadcast a service request upon receiving instruction for generating the service request from a user, wherein a user equipment is coupled to the computing network for generating and broadcasting the service request when in operation,
provide a plurality of service bids by a plurality of second autonomous economic agents in response to the generated service request via the open economic framework, wherein the plurality of second autonomous economic agents is hosted within the open economic framework
record one or more transaction events between the first autonomous economic agent and the plurality of second autonomous economic agents,
select at least one of second autonomous economic agent based on preferences associated with the service request and a confidence factor associated with the plurality of the second autonomous economic agents, wherein the confidence factor is acquired by the first autonomous economic agent from the open economic ledger, wherein the plurality of second autonomous economic agents associated with a plurality of service providers, wherein each of the service providers comprise at least one service component,
perform an execution of a smart contract between the at least one selected second autonomous economic agent and the first autonomous economic agent, wherein the execution of the smart contract is subject to a degree of data protection implemented via the decentralized computing network that is adaptively adjusted depending upon one or more parameters of the smart contract, and
enable at least one service component of the service provider associated with the selected second autonomous economic agent to provide the service to the user.

Optionally, when implementing the degree of data protection, the first autonomous economic agent and the plurality of second autonomous economic agents encrypts the one or more transaction events by employing intelligent algorithms to secure the open economic framework, wherein the intelligent algorithms include adaptive data encryption and data obfuscation processing operations.

More optionally, when the decentralized computing network is in operation, the adaptive data encryption and data obfuscation processing operations are selected depending upon at least one of: a temporal rate of execution of smart contracts via a given node of the decentralized computing network, considerations associated with smart contracts being executed via a given node of the decentralized computing network.

More optionally, the adaptive data encryption and data obfuscation processing operations employ a combination of following data protection processes: encryption, decryption, data obfuscation by swapping one or more bits of data bytes, addition of obfuscating redundant data (namely, “data decoys”), temporally randomized transmission times for data within the decentralized computing network.

It will be appreciated that features of the present disclosure are susceptible to being combined in various combinations without departing from the scope of the present disclosure as defined by the appended claims.

### DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of a system that provides, when in operation, a service via an open economic framework (OEF) to a user, in accordance with an embodiment of the present disclosure;

FIG. 2 is an illustration of an implementation of the open economic framework of FIG. 1, in accordance with an embodiment of the present disclosure;

FIG. 3 is an illustration of steps of a method of providing a service to a user via open economic framework, in accordance with an embodiment of the present disclosure; and

FIG. 4 is an illustration of an optional implementation of the open economic framework of FIG. 1, in accordance with an embodiment of the present disclosure about the collaborative service bid.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

In overview, embodiments of the present disclosure are concerned with a system of providing services autonomously to a user via an open economic framework. Moreover, embodiments of the present disclosure are concerned with an open economic framework for providing services autonomously to users.

According to a first aspect, an embodiment of the present disclosure provides a system that provides, when in operation, services autonomously via an open economic framework (OEF) implemented on a decentralized computing network, characterised in that the system comprises:
a first autonomous economic agent associated with a user equipment coupled to the computing network that generates and broadcasts, when in operation, a service request, wherein the first autonomous economic agent receives instruction for generating the service request from a user using the user equipment;
a plurality of second autonomous economic agents hosted within the open economic framework associated with a plurality of service providers, wherein each of the service providers comprises at least one service component, wherein the plurality of second autonomous economic agents provides, when in operation, the first autonomous economic agent with a plurality of service bids via the open economic framework in response to the generated service request; and
an open economic ledger linked to the first autonomous economic agent and the plurality of second autonomous economic agents, wherein the open economic ledger when in operation, records one or more transaction events between the first autonomous economic agent and the plurality of second autonomous economic agents,

wherein the first autonomous economic agent when in operation, selects at least one of the second autonomous economic agents based on the preferences associated with the service request and a confidence factor of the least one of the second autonomous economic agents, and wherein the at least one selected second autonomous economic agent when in operation, performs an execution of a smart contract with the first autonomous economic agent for providing the service autonomously, and wherein the execution of the smart contract is subject to a degree of data protection implemented via the decentralized computing network that is adaptively adjusted depending upon one or more parameters of the smart contract.

The present disclosure provides a system that provides services autonomously by accessing the open economic framework implemented on a decentralized computing network, wherein the decentralized computing network includes a plurality of computing devices interconnected to communicate with one another. According to the present disclosure, the system comprises a first autonomous economic agent, a plurality of second autonomous economic agent and an open economic ledger. Furthermore, the plurality of autonomous economic agents is operable to execute a process of providing the service to the user autonomously. Moreover, throughout the present disclosure the term “autonomously” is defined as executing a task or implementing a set of instructions without any manual interference or need of any user assistance in accordance to a set of parameters and guidelines provided by the user. The system takes decisions in an intelligent manner, namely in an adaptive manner wherein the system includes learning algorithms whose operation is adaptively modified by data being communicated via the communication network of the system, for achieving the objectives based on the set of parameter and guidelines provided by the user.

Optionally, when implementing the degree of data protection, the first autonomous economic agent and the plurality of second autonomous economic agents encrypts the one or more transaction events by employing intelligent algorithms to secure the open economic framework, wherein the intelligent algorithms include adaptive data encryption and data obfuscation processing operations. By enhancing the degree of data protection, the decentralized computing network is less prone to being disrupted by malicious third parties, for example by injection of computer viruses or by selective eavesdropping and substitution of data flows within the decentralized computing network. By employing data protection within the decentralized computing network that is adaptively adjusted depending upon one or more parameters of smart contracts implemented within the system, the system can be both highly efficient in its operation and also highly robust to attack.

More optionally, when the decentralized computing network is in operation, the adaptive data encryption and data obfuscation processing operations are selected depending upon at least one of:

(i) a temporal rate of execution of smart contracts via a given node of the decentralized computing network,

(ii) considerations associated with smart contracts being executed via a given node of the decentralized computing network.

More optionally, the adaptive data encryption and data obfuscation processing operations employ a combination of following data protection processes:
(i) data encryption, for example using a private-public key encryption regime;
(ii) data decryption, for example using a private-public key encryption regime;
(iii) data obfuscation by swapping one or more bits of data bytes, wherein such swapping is performed pursuant to a swapping template that is communicated within the decentralized computing network in an encrypted manner;
(iv) an addition of obfuscating redundant data (namely, “data decoys”), for example, added as “padding” to data being communicated within the decentralized computing network; and
(v) temporally randomized transmission times for data within the decentralized computing network.

It will be appreciated that combinations of obfuscation, for example swapping of nibbles of bytes, and encryption (likewise, corresponding de-obfuscation and decryption) are capable of approaching a “one time pad” degree of data protection which can only be attacked by using extreme amounts of data processing resources that would not normally be available to malicious third parties.

According to the present disclosure, the system includes the first autonomous economic agent associated with a user equipment is configured to generate a service request based on instructions received from the user using the user equipment. Furthermore, the instructions include information related to a service requested by the user. Moreover, the first autonomous economic agent is configured to broadcast the generated service request to the plurality of second autonomous economic agent within the open economic framework.

According to the present disclosure, the system includes a plurality of second autonomous economic agent, wherein each of the second autonomous economic agent is associated with a service provider comprising at least one service component configured to provide the service the user. Moreover, the plurality of second autonomous economic agents, when in operation, receive the broadcasted service request and provide the first autonomous economic agent with a plurality of service bids in response to the broadcasted service request.

According to the present disclosure, the system includes open economic ledger, wherein the open economic ledger is a distributed ledger linked with the first autonomous economic agent and the plurality of second autonomous economic agent. Furthermore, the open economic ledger records one or more transaction events between the plurality of autonomous economic agents. Moreover, the one or more transaction event corresponds to the exchange of data between the plurality of autonomous economic agents, wherein the data includes: the confidence factor of one or more autonomous economic agent, information associated with remuneration, service request, service bid, and smart contract.

Optionally, for ensuring robustness to malicious third-party attacks, the open economic ledger is duplicated a plurality of times within the decentralized computing network, wherein a majority voting process and/or a correlation process is used to verify a reliability of entries recorded in the open economic ledger to avoid operation of the decentralized computing network from being frustrated by malicious third-party attacks. Beneficially, hardware operation of the decentralized computing network is implemented to protect the open economic ledger, as aforementioned.

According to the present disclosure, at least one of the second autonomous economic agent associated with at least one service bid is selected by the first autonomous economic agent. Moreover, the selection of the at least one of the second autonomous economic agents is based on the preferences associated with at least the service request and a confidence factor associated with the plurality of second autonomous economic agents. Additionally, the first autonomous economic agent acquires the data related to preference associated with the service request and a confidence factor from the open economic ledger.

Furthermore, the at least one selected second autonomous economic agent executes a smart contract and the at least one service component of the service provider associated with the selected second autonomous economic agent provides the service to the user. Moreover, the smart contract includes a plurality of conditions associated with the selected service bid for providing the service.

Furthermore, the confidence factor comprises feedback information provided by user based on their experiences related to the services provided by the second autonomous economic agent. The system further collates information on the provided services for suggesting related feedbacks to the user. Moreover, the information includes at least one of a historical information and number of services provided. Furthermore, the conditions associated with the service request include at least one of: a timeframe needed for completion of the service, a cost associated with the service, a quality associated with the service, at least one customised instruction associated with the service.

In an embodiment, the first autonomous economic agent and the plurality of second autonomous economic agents encrypts the one or more transaction events. Furthermore, the one or more transaction events are encrypted by employing intelligent algorithms to secure the open economic framework; optionally, the intelligent algorithms operate employ encryption regimes, for example various combinations of encryption keys and manners of distributing such encryption keys within the decentralized computing network, depending upon historical experienced gained from previous third-party malicious attacks to the decentralized computing network. Moreover, the intelligent algorithms include adaptive data encryption and data obfuscation techniques. Furthermore, the adaptive data encryption and data obfuscation advantageously make the open economic framework more robust and prevent the system implemented on the decentralised computing network from unwanted intrusions, for example third-part malicious attacks. Moreover, the adaptive data encryption employed by the first autonomous economic agent and the plurality of second autonomous economic agents encrypts the data being exchanged based the type of data. Moreover, the data includes the confidence factor of one or more autonomous economic agent, information associated with remuneration, service request, service bids.

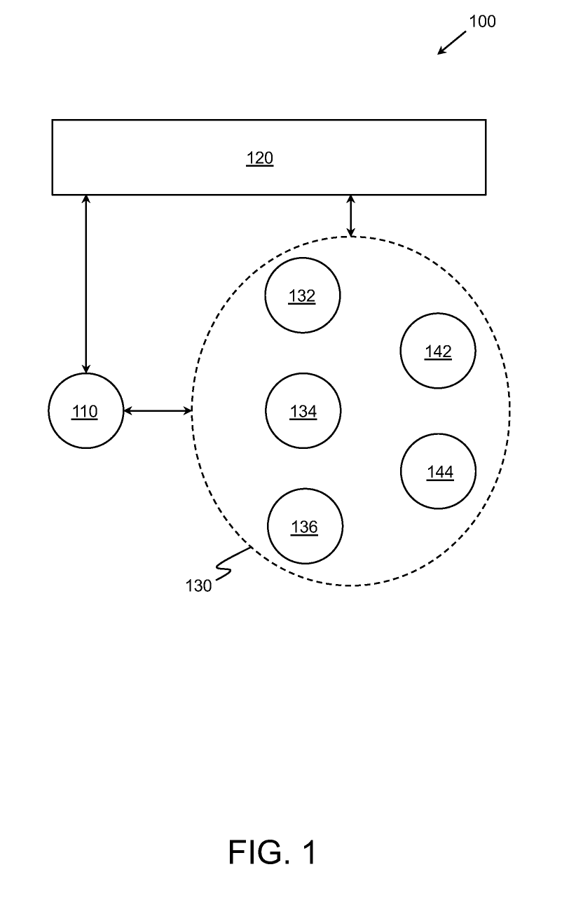

Referring to FIG. 1, there is shown a block diagram of the system 100 for providing a service autonomously to a user by accessing an open economic framework for, in accordance with an embodiment of the present disclosure. As shown, the system 100 for providing the services autonomously to the user via the open economic framework includes the user equipment 110, the open economic ledger 120 and the plurality of service providers 130, 132, 134, 136, 142, 144 that are capable of providing the service. It will be appreciated that the service includes, for example, procurement of technical materials, processing of the technical materials and installation of the processed technical materials. For example, the technical service includes methods for (of) constructing a building, repairing a road vehicle, processing biological material in a garden, applying protective coatings to exposed surfaces of buildings and so forth.

According to the present disclosure, in the system 100 accesses when in operation, the open economic framework (OEF), wherein the open economic framework is an arrangement for providing a service to the user; throughout the present disclosure, the term ‘open economic framework’ as used herein relates to an arrangement of programmable and non-programmable components and/or modules. Furthermore, the arrangement of programmable and non-programmable components and/or modules is configured, namely is operable, to receive and process a service requested by the user. In providing the OEF, the system employs a data communication network that operates in an intelligent manner, namely the decentralized computing network (for example implemented using a data communication network) is controlled using one or more algorithms that are adaptively able to change their operating parameters based upon data being exchanged with the system 100 (for example, selected depending upon a magnitude of consideration being exchanged via execution of smart contracts and/or a spatial concentration of smart contracts being executed at any given computing node of the decentralized computing network), wherein the algorithms ensure a more efficient data exchange between the economic ledger and the service providers, for example by employing selectively varying degrees of encryption, data obfuscation and temporal data scrambling by encryption-like varying of data transmission times to frustrate third-party unauthorized disruption of the data communication network.

Optionally, the open economic framework is the arrangement of computing devices forming the decentralised computing network, wherein the each of computing devices implements the autonomous economic agent associated to a user or service provider with their respective profile registered on the system through which the autonomous economic agent can access the open economic framework. Moreover, the open economic framework facilitates data communication between the plurality of autonomous economic agents and the open economic ledger to allow provisions of autonomous service delivery.

Optionally, the system 100 is a peer-to-peer distributed open economic framework that is operable to provide seamless, connected movement of data, people, services, autonomous economic agents, goods and so forth from a source to a destination in a preferred way and/or manner that is safest, fastest, and comparatively cost-effective, for example in a manner as aforementioned. However, the distributed open economic framework is optionally implemented in alternative manners, for example by way of a plurality of smaller peer-to-peer networks coupled together via encrypted data “highways” in a star configuration, so that damage to a given small peer-to-peer network is isolated to that given peer-to-peer network and does not spread to other small peer-to-peer networks; the data “highways” optionally employ alternative forms of smart contract for facilitating data communication therethrough in comparison to within each of the plurality of small peer-to-peer networks. In an embodiment, the system 100 provides a digital environment that is representative of a real-world environment via the open economic framework.

The system 100 is implemented on the decentralized computing network for providing a service to a user via the open economic framework. Throughout the present disclosure, the term ‘decentralised computing network’ as used herein relates to an arrangement of a plurality of computing devices interconnected to communicate with one another. In operation, each of the computing devices can perform as both client and server. Optionally, the decentralized computing network is a decentralized structured peer-to-peer network. Specifically, the decentralized structured peer-to-peer network represents a decentralized computing environment within a peer-to-peer network.

Optionally, the decentralised computing network includes a plurality of computing devices, wherein the computing devices includes the plurality of user equipment's and service provider equipment's, wherein each of the user equipment's and service provider equipment's includes a data processing arrangement that implements the autonomous economic agent.

Optionally, the decentralised computing network includes wired and/or wireless communication means comprising a software component, a hardware component, a network adapter component and a combination thereof. Furthermore, the communication network may be an individual network, or a collection of individual networks, interconnected with each other and functioning as a single large network. Such individual networks may be wired, wireless, or a combination thereof. In an example, the communication network may include Bluetooth®, Internet of things (IoT), Visible Light Communication (VLC), Near Field Communication (NFC), Local Area Networks (LANs), Wide Area Networks (WANs), Metropolitan Area Networks (MANs), Wireless LANs (WLANs), Wireless WANs (WWANs), Wireless MANs (WMANs), the Internet, telecommunication networks, radio networks, and so forth.

According to the present disclosure, the system 100 includes the plurality of autonomous economic agent (referred to herein as “autonomous economic agent” or “AEA”). Throughout the present disclosure, the term “autonomous economic agent” as used herein, relates to software modules that execute one or more actions. Such actions may include communication of the autonomous economic agents with each other, processing of information and so forth. In an example, the AEAs are configured to employ artificial intelligence (AI) algorithms and machine learning for execution of the one or more tasks, for example as aforementioned. The artificial intelligence (AI) algorithms can be used, for example in an adaptive manner depending upon data flows occurring through the system 100 to vary types of data encryption and data obfuscation employed in communication between the economic ledger and the service providers to reduce a risk of malicious third-party interference within the open economic framework hosted by the system 100. In another example, the AEAs are associated with a digital environment (referred to herein as “Open Economic Framework” or “OEF”). The OEF is a computing framework that enables execution of tasks associated with various AEAs within the OEF.

Throughout the present disclosure, the term “user” as used herein relates to an individual that is operable to use the system 100, to access the open economic framework, for outsourcing a service for the individual. It will be appreciated that the term “user” 110 is used interchangeably herein as a “client”. In an example, a user may be an individual accessing the open economic framework to outsource a service such as cleaning a garden area of the individual's real-estate property. In an example, the user may be a virtual personal assistant (an autonomous program or a bot) that is operable to use the system 100, to access the open economic framework, for providing service in lieu of the individual, for example for automatic ordering of a replacement component part for a manufacturing facility. In such an example, the virtual personal assistant may be operable to record one or more preferences of an individual for performing the service that may be outsourced by employing the system 100.

Throughout the present disclosure, the term ‘service’ as used herein relates to a means of performing any activity and/or providing assistance for performing such activity for the user; the “service” may, for example relate to a technical service such as machining, cutting, dying, sewing, washing and so forth. In an example, a service may be an activity of hiring one or more logistical services for transporting an object associated with the user from a source to a destination. In another example, the service may be information to assist the user to identify a logistical service for transporting the object associated with the user from the source to the destination.

The system for providing the service to the user via the open economic framework includes a user equipment 110 associated with the user, for generating a service request, wherein the user equipment 110 is associated with the first autonomous economic agent from the plurality of autonomous economic agents.

It will be appreciated that the term “user equipment” 110 is used interchangeably herein as a “client device”. Additionally, the term first autonomous economic agent is used interchangeably herein as a “first AEA” or a “client AEA”.

For example, the client device 110 is associated with a user that wants to obtain a service using the system 100. In such an instance, the user uses the client device 110 to generate the service request corresponding to the service required by the user. Furthermore, the service request is generated by the user using the user equipment 110. Throughout the present disclosure, the term “user equipment” as used herein relates to an electronic computing device associated with (or used by) a user for accessing the open economic framework via the system 100. Specifically, the user equipment 110 associated with the user include hardware, software, firmware, or a combination of these. Furthermore, the user equipment 110 relates, for example, to portable computing devices and/or fixed computing devices. Examples of the user equipment 110 include but are not limited to, desktop computers, laptop computers, tablet computers, phablet computers, smartphones, and personal digital assistants.

Optionally, the user equipment 110 is operable to render user interfaces thereon, for example graphical user interfaces (GUIs). Furthermore, the user interfaces are operable to facilitate the generation of service requests by the user via the user equipment 110. Furthermore, the user interfaces may include icons, on-screen keyboards, pull-down menus, buttons, control options, and audio-visual indicators to receive input from the at least one user to generate a service request; optionally, when the user is handicapped, for example blind, an audio and/or tactile user interface is employed. Additionally, the user interface is used to provide text input, voice input, keypad input and so forth. In such example, the keypad input may be provided via a virtual keyboard and/or a physical keyboard. Alternatively, optionally, the user is associated with one or more user equipment. For example, a single user may be associated with three user equipment, namely, a desktop computer, a tablet computer, and a smartphone.

Throughout the present disclosure, the term “service request” as used herein relates to a request generated by the user using the user interfaces rendered on the user equipment 110. Furthermore, the user interface is operable to provide a plurality of options for acquiring specific instructions from the user to provide the service. Optionally, the preferences associated with the service request includes at least one of a timeframe, namely a time interval or a time duration, needed for completion of the service, a cost (namely financial consideration) associated with the service, a quality associated with the service, at least one customised instruction associated with the service. For example, the user may use the user interface to define the service required by the user; in such an instance, the service may be cleaning a garden area of the user's real estate property. In an example, the user may classify a fixed time period within which the user prefers the service to be provided; in such an instance, the user may classify the fixed time period from 09:00 AM to 11:00 AM for cleaning the garden area. In another example, the user may use the user interface to define an amount of money (namely financial consideration) the user prefers to spend for the service; in such an instance, the user may define the amount of money to be £200 for cleaning the garden area. In yet another example, the user may categorise a quality associated with the service; in such an instance, the user may categorise quality associated with the service to be of a “high quality”, wherein whether a service is “high quality”, “medium quality” or “low quality” is determined from an aggregate of a given type of service being provided to a representative population of users within a geographical area. In another example, the user may include customised instruction such as special instruction for performing the service; in such an instance, the user may prefer the service to be an eco-friendly service (namely, implemented in an environmentally sustainable manner).

The system 100 includes the plurality of service provider that are capable of providing the service, wherein each of the plurality of service providers is associated with the second autonomous economic agent. Moreover, each of the service provider is associated with at least one service provider equipment, wherein the service provider equipment is configured to implement the second autonomous economic agent. Throughout the present disclosure, the term ‘service provider equipment’ as used herein relates to an electronic computing device associated with (or used by) a service provider for accessing the open economic framework via the system 100. Specifically, the service provider equipment associated with the service provider include hardware, software, firmware, or a combination of these. Furthermore, the service provider equipment relates, for example, to portable computing devices and/or fixed computing devices. Examples of the service provider equipment include but are not limited to, desktop computers, laptop computers, tablet computers, phablet computers, smartphones, and personal digital assistants.

It will be appreciated that the term “second autonomous economic agent” 110 is used interchangeably herein as a “service provider autonomous economic agent”. Additionally, the term “second autonomous economic agent” is used interchangeably herein as a “second AEA” or a “service provider AEA”.

Furthermore, each of the second AEA is configured to generate at least one service bid in response to the service request generated by the first AEA. However, it will be appreciated that the plurality of second AEA and the first AEA are operable to perform interchangeable functions i.e. the second AEA associated with the service provider may simultaneously operate as a first AEA that may be acquiring services from one or more other second AEA. Similarly, the first AEA may be second AEA providing services to one or more other first AEAs.

In an embodiment, the plurality of second autonomous economic agents includes a first set of second autonomous economic agents and a second set of second autonomous economic agents, wherein the first set of second autonomous economic agents and the second set of second autonomous economic agents when in operation, generates a collaborative service bid in response to the generated service request. Furthermore, the first set of second autonomous economic agents when in operation, executes at least a portion of the service, and wherein the second set of second autonomous economic agents when in operation, executes the remaining portion of the service. Moreover, the at least one second AEA of the first set of second AEA may operate as a first AEA to hire a second AEA from the second set of second AEA to execute the remaining portion of the service.

The system 100 includes a plurality of service components associated with the plurality of service providers that are capable of providing the service. Throughout the present disclosure, the term “service providers” as used herein relates to organizations, and/or individuals and/or computing devices (for example, artificial intelligence (AI) engines) capable of providing the service that is requested by the user. Optionally the service providers are operable to respond to the service request generated by the user via the user equipment 110. For example, a service provider may be an organisation that provides a home cleaning services. In such an instance, the service provider providing home cleaning service may respond to a service request generated by the user for cleaning a garden area of the real estate property. Furthermore, the service provider includes service components for providing the service requested by the user. Throughout the present disclosure, the term “service components” as used herein relates to one or more programmable and non-programmable elements that are used by the service provider for providing the service requested by the user. In an example, a service provider may use a service component such as a drone for responding to a service request generated by the user, such as a cleaning service of a garden area of a real estate property of the user (for example, for inspecting building roof areas to determine whether or not cleaning and/or repair of the roof areas is required to ensure that they are watertight to precipitation such as rain and snow). Optionally, a service provider includes a plurality of service components for providing the service requested by the user via the user equipment 110. Optionally, each of the plurality of service components are associated with at least one of the plurality of autonomous economic agents. In an example, the autonomous economic agents are associated with the open economic framework. The autonomous economic agents are associated with a location within the open economic framework, such as an autonomous economic agent associated with a service provider may be associated with location of the service provider (within the real-world environment) in the open economic framework. It will be appreciated that such location of the autonomous economic agents may change depending on the location of the service provider. For example, when the service provider relocates to another city, location of the autonomous economic agent associated with the service provider within the open economic framework may change to correspond with new location of the service provider.

Optionally, the autonomous economic agents are operable to control the functioning of the service components used by the service providers for providing the service requested by the user. For example, a service component, such as a drone, used to provide a garden cleaning service, may include a software module that controls certain parameters of the operation of the drone. In such an instance, the certain parameters controlled by the software module may be a fixed time duration in which the drone is providing the cleaning service, a fixed location in which the drone is providing the cleaning service, a quality of cleaning, such as high perception cleaning, and so forth.

Furthermore, the system 100 provides when in operation, various tools, security protocols, rules and suchlike for the execution of tasks including, but not limited to, communication, processing of information and so forth, between different autonomous economic agents associated with the system 100.

Additionally, the open economic framework and the system 100 is operable to define the infrastructure, rule and/or protocols that define the communication between the autonomous economic agents. Consequently, the open economic framework and the system 100 may deny access to one or more autonomous economic agents to operate within the open economic framework upon determining that the autonomous economic agents do not comply with the set of rules and/or security protocols. Moreover, the open economic framework and the system 100 enables the provision of a decentralized economic market for enabling various services to be provided and/or procured by the autonomous economic agents. Such decentralized economic market may be representative of a real-world environment, such as a real-world market where one or more services are provided and/or procured.

Optionally, the open economic framework is operable to define an area in the decentralised computing network, within which an autonomous economic agent operates. For example, an autonomous economic agent operating within the system 100 may be operable to communicate with other autonomous economic agents. Optionally, autonomous economic agents are operable act to provide a service to other autonomous economic agents. Additionally, the autonomous economic agents are operable request services of other autonomous economic agents. For example, the open economic framework may for a miniature structure within the open economic framework wherein autonomous economic agents that are proximal to each other may interact and serve as both service provide and clients.

Optionally, the autonomous economic agent is an autonomous economic agent. Additionally, the autonomous economic agent is configured to employ artificial intelligence (AI) algorithms for execution of the one or more actions. For example, the autonomous economic agent module may include artificial intelligence (AI) image recognition algorithms for performing automatic inspection of gardens and rooftops and making recommendations of how to maintain the gardens and rooftops (for example, with regard to garden plant husbandry or coatings to be applied to roof areas to ensure that they are watertight).

Optionally, the service providers include computing devices for communicating and controlling the service components. It may be appreciated that the computing devices embody similar attributes as the user equipment 110. For example, the computing devices include but are not limited to, desktop computers, laptop computers, tablet computers, phablet computers, smartphones, and personal digital assistants. Furthermore, the computing devices used by the service providers include autonomous economic agents for communicating and controlling the service components. Optionally, there are employed customized digital hardware elements in the system 100 for providing aforementioned data ‘highways” between a plurality of smaller peer-to-peer networks for rendering the system 100 particularly robust against systemic failure in an event of a major malicious third-party attack to the system 100. Such robustness is important for various aforementioned agents using the system 100, when in operation.

According to the present disclosure, each of the first autonomous economic agents and the second autonomous economic agents is connected to a data processing arrangement (not shown) individually, wherein the plurality of data processing arrangement associated with the plurality of autonomous economic agents collectively forms the decentralized computing network. In one example, the client AEA is connected to a data processing arrangement provided on a portable communication device associated with the user.

Optionally, the data processing arrangement of the plurality of autonomous economic agents may be the data processing arrangement of the plurality of user equipment and the plurality of service providers equipment.

In another example, the each of the service provider AEAs are connected to individual data processing arrangements that are further coupled to the service components 210 to 250. In such an instance, providing the service provider AEAs on the respective data processing arrangements enables communication of the various service provider AEAs for collaboration therebetween, for generation of the service bid.

Throughout the present disclosure, the term “data processing arrangement” as used herein relates to programmable and/or non-programmable components configured to execute a software application. The data processing arrangement includes hardware, software, firmware or a combination of these, suitable for storing and processing various information and services accessed by the one or more user using the one or more user equipment 110.

Optionally, the data processing arrangement includes functional components, for example, a processor, a memory, a network adapter and so forth. Additionally, the data processing arrangement includes device-functionality software and/or operating system software configured to execute other programs/software application including various modules for storing and processing information, such as processing various information and services accessed by the one or more user. Furthermore, the user interface rendered on the user equipment 110 enables the user and the first AEA associated with the user to communicate with plurality of autonomous economic agents.

Additionally, the user is operable to register itself by generating a user profile on the system 100. Subsequently, the user uses the user profile to generate a service request. The data processing arrangement of the first AEA is operable to receive the generated service request from the user equipment 110. For example, a user may wish to travel (namely, “make a journey”) from a source (namely, a start location), such as the user's home at Birmingham to a destination (namely, an end location), such as a hotel in Amsterdam. In such an example, the user may use the user interface rendered on the user equipment 110 to generate the service request. In such an example, the user may use the user interface to define the service request, in such an instance the user may define the service request by specifying the start and end locations of the journey, a series of preferences about journey expectations and a time window (namely, a time period or a time interval) during which the journey can take place and a cost range associated with making the journey.

Furthermore, the user may also define a time frame (namely, a time period or a time interval) within which the user prefers to view the response the service providers providing the service. Optionally, the service providers are operable to register with the open economic framework in order to provide service to the user. Subsequently, the plurality of AEA is associated with the service providers are provided with the access to the open economic ledger 120 for storing the activities performed by the service components, a mobile wallet to store digital tokens that are exchanged by the autonomous economic agent associated with the service components and/or the service providers. Furthermore, the digital tokens (or a portion of a digital token) are exchanged between at least two autonomous economic agents to provide remuneration for a service performed by the service component or charged a penalty for not performing the service requested by the service component.

The data processing arrangement of the first AEA is operable to receive a plurality of service bids from the plurality of second autonomous economic agents in response to the received service request. Optionally, the data processing arrangement of the first AEA is operable to generate and broadcast the received service request from the user to the plurality of second AEA. Subsequently, the plurality of autonomous economic agents associated with the service providers is configured to provide the data processing arrangement of the first AEA with the plurality of service bids.

In an example, in response to the aforesaid request generated by the user for travelling from the user's home at Birmingham to a destination, such as a hotel in Amsterdam, a plurality of service providers that are travel agencies may bid for the smart contract for providing the service of transporting the user from Birmingham to Amsterdam. In such an instance the travel agencies may include various service components such as cars (automobiles), bikes, air taxis and so forth. Furthermore, such service components may include individual autonomous economic agents for themselves. Additionally, the travel agencies including various service components are registered with the open economic framework.

Optionally, the service provider is configured, namely is operable, to define the service provided in the service bids provided in response to the service request generated by the user. In an example, a service bid of a service provider may include a timeframe needed for completion of the service, a cost associated with the service, at least one location associated with the service, a quality associated with the service, at least one preference associated with the service.

Optionally, at least one service bid of the plurality of service bids is a collaborative service bid associated with two or more autonomous economic agents. In an example, the service bid for the aforesaid service request for transporting the user from Birmingham to Amsterdam may include at least two service providers such as travel agents. In such example, one service provider may be from Birmingham and the other service provider may be from Amsterdam. In such example, the service provider from Birmingham may provide service based on the rules and norms of the United Kingdom and the service provider from Amsterdam may provide service based on the rules and norms of the Netherlands. Therefore, the service bid generated by the service providers may include the rules and norms of United Kingdom and Netherlands. In such instance the autonomous economic agents associated with the service components of the service provider from Birmingham may communicate with the autonomous economic agents of the service components of the service provider from Amsterdam. Furthermore, the autonomous economic agents are operable to determine the travel route of the user that is safe, fast, and cost-effective.

The service component associated with the at least one selected second autonomous economic agent is configured, namely is operable, to provide the service to the user, and the data processing arrangement of the second AEA is configured, namely is operable, to receive a feedback from the user associated with the provided service. The user is operable to provide a feedback in response to the service provided by the user. Optionally the feedback from the user is a user rating of the service. Additionally, the user is operable to provide the feedback via the user interface of the user equipment 110. Optionally, the user rating is based on a degree of satisfaction of the user. In an example, a user may avail a transportation service provided by a service component such as a cab (for example, a taxi cab), associated with a service provider, such as mobility service providers. Subsequently, the user may provide the service provider with a user rating as a feedback describing the amount of satisfaction experienced by the user while availing the service. In such instance the feedback provided by the user may be stored in the open economic ledger 120.

The data processing arrangement of the first AEA is configured, namely operable, to select at least one service bid from the plurality of received service bids. The data processing arrangement of the first AEA is configured, namely operable, to analyse the plurality of service bids received from the plurality of service providers. Optionally, the data processing arrangement of the first AEA includes software that is configured, namely operable, to analyse the plurality of service bids received from the plurality of service providers to determine at least one service bid that is most appropriate to satisfy the service request. Furthermore, such determination is made based on a one or a number of criteria such as safest, fastest, and comparatively cost-effective with respect to the other service bids provided by the other service providers. The data processing arrangement the first AEA is configured, namely operable, to select at least one service bid wherein the selection of the at least one service bid is based on preferences associated with the service request generated by the user, a nature of service associated with the selected service bid and a confidence factor associated with the autonomous economic agent offering the selected service bid.

Optionally, the preferences associated with the service request generated by the user relates to the choices preferred by the user. For example, the user may prefer for the service to be provided in a specific time frame and/or interval and within a specific financial consideration. In such an example, the user may also prefer for the service to be performed in an eco-friendly manner.

Optionally, the nature of the service associated with the selected service bid relates to the essential attributes associated to the service provided by the service provider. For example, the essential attributes associated to a service may include the type of the service, the time-frame that the service may be provided in, the level of quality that the service may be provided with, the mode of performing the service, the cost (namely financial consideration) associated for acquiring the service and so forth. Furthermore, the nature of the service is operable to define a compatibility of the service with respect to the service request generated by the user. Beneficially, for a service bid to be selected as a preferred service, the nature of that service has to complement the preferences associated with the service request generated by the user.

Throughout the present disclosure, the term ‘confidence factor’ as used herein relates to a means of defining quality of the service provider and the associated service component, and the satisfaction attained by the user from the consummation of the delivered service. Optionally, “quality” relates to parameters of results of a given task when implemented exceeding one or more thresholds defining a particular grade of quality, wherein the parameters can relate to a spatial density of optical defects (for example, for cleaning activities), adhesion of layers (for example, for paint and redecorating activities), number of bacteria per unit volume (for example, for washing activities), and so forth. Furthermore, the satisfaction attained by the user is related to the fulfillment of the preference of the service request generated by the user. Optionally, the user is operable to provide the satisfaction in the form of user ratings and feedback via the graphical user interface (GUI). For example, the graphical user interface (GUI) may provide the user with a five star shaped graphical elements to designate the satisfaction experienced by the user. In such example, the number of selected stars represents the satisfaction of the user, wherein the least satisfied could be represented by selecting a single star and the maximum satisfaction could be represented by selecting the entire five stars. In such example, the user may select four stars to represent the satisfaction attained by the user. In another example, the graphical user interface (GUI) may include an input section wherein the user may type in additional comments to describe the service provided.

The feedback provided by the user is used to update a confidence factor of the autonomous economic agent associated with the service provider; “confidence factor” can relate, for example, to a probabilistic likelihood of meeting defined quality criteria, probability of delivering a defined service within a defined time period, and so forth. Furthermore, the confidence factor associated with each of the plurality of service providers is stored in the open economic ledger 120 (referred to, herein later as “OEL”). Such storage of the confidence factor includes storing trust information associated with the second autonomous economic agents on the OEL 120, this enables to provide transparency of trust information and consequently, the services provided using each of second autonomous economic agents. Additionally, providing the confidence factor on the OEL 120 enables to provide higher security for users of the system 100, as tampering with the OEL 120 to furnish inaccurate trust information associated with the service provider will be computationally expensive and therefore, unprofitable.

According to the present disclosure, the open economic ledger 120 is linked to the first autonomous economic agent and the plurality of second autonomous economic agent, wherein the open economic ledger 120 configured to record one or more transaction events between the first autonomous economic agent and the plurality of second autonomous economic agents. Moreover, the one or more transaction events corresponds to the exchange of data between the plurality of autonomous, wherein the data includes: the confidence factor of one or more autonomous economic agent; information associated with remuneration; service request; service bid; and smart contract.

In an example, the plurality of service bids is provided by the second AEA in response to the service request generated by the first AEA, wherein the plurality of service bids is stored in the OEL and the service request generated and broadcasted by the first AEA is also stored on the OEL.

Optionally, the open economic ledger is configured to record the progress of the process for providing the service to the user by monitoring the exchange of data between the first AEA and the second AEA. In an example, let us say that the progress of the process of providing service to the user is in a step where the service is being executed by the second AEA using the plurality of service components and two of three service components have done their work. So, the OEL will be updated by the second AEA about the status of the service being provided. More optionally, the first AEA is configured to acquire the data associated with the progress of the service and provide the acquired data to the user.

Throughout the present disclosure, the term ‘open economic ledger’ 120 as used herein relates to a digital ledger that records peer to peer digital transactions or transaction events. The OEL 120 is a permanent cryptographically protected digital ledger. Furthermore, the OEL 120 is a type of blockchain that is capable of operating within the decentralised computing network where the system 100 is implemented. Optionally, OEL 120 is a data structure that comprises a series of usually time-stamped blocks where each block includes data corresponding to one or more transactions performed by the autonomous economic agents. Furthermore, once data is entered into OEL 120, entry is irrefutable. Additionally, any tampering with the data would be reflected and is thus easily detected.

Furthermore, the data processing arrangement of the first AEA is configured, namely is operable, to compare the confidence factor associated with each of the second autonomous economic agents on the OEL 120 to determine a service provider's autonomous economic agent associated with higher confidence factor. For example, the confidence factor is associated with a likelihood of providing a successful service by a service provider AEA, for example in a manner as aforementioned. In such an instance, the data processing arrangement of the first AEA is operable to compare characteristics of trust information associated each of the plurality of second autonomous economic agents (associated with generation of the service bids). In one example, the data processing arrangement of the first AEA is configured, namely operable, to compare user rating of the autonomous economic agents associated with the service components and the number of services provided by the plurality of service providers. In such an instance, the data processing arrangement of the first AEA is configured, namely operable, to determine the second autonomous economic agent associated with a comparatively higher service rating and comparatively higher number of services provided. Furthermore, the second autonomous economic agent associated with the higher service rating and higher number of services provided is associated with higher confidence factor. It will be appreciated that such higher confidence factor is further associated with higher likelihood of providing a successful service and receiving a positive service rating for the service provided as compared to another second autonomous economic agent associated with lower service rating and/or lower number of services provided.

Moreover, the data processing arrangement of the first AEA is configured to select the determined service provider's autonomous economic agent associated with the higher confidence factor for providing the service. For example, the service bid associated with the selected second autonomous economic agent is assigned the service request. According to an embodiment, an agreement is generated by the data processing arrangement of the second AEA, wherein the agreement is associated with information related to the service to be provided. In one example, the agreement includes information such as a cost agreed by the second autonomous economic agent for providing the service, a time request by the user for providing the service, one or more parameters specified by the user (as mentioned herein above) and so forth. Subsequently, the service is provided using the service component associated with the selected service provider AEA.

Optionally, the selected second autonomous economic agent is remunerated by a digital token for the provided service. For example, the digital token (referred to, herein later as the “Open Economic Token” or “OET”) is a cryptocurrency. In such an instance, the cryptocurrency is used by the client autonomous economic agent for remunerating the selected second autonomous economic agent for the service provided and/or by the second autonomous economic agent for acquiring one or more services by other second autonomous economic agents. It will be appreciated that such implementation of the digital token as the cryptocurrency enables secure and digital transaction between the autonomous economic agents.

Optionally, information associated with the remuneration is stored on the OEL 120. For example, transaction information associated with the OETs is stored on the OEL 120 along with confidence factor information associated with the provided service. Such storage of the transaction information on the OEL 120 enables an easy and reliable verification of the confidence factor information associated with the second autonomous economic agent (such as services provided by the second autonomous economic agent and/or costs imposed on the client autonomous economic agent for providing the services). Optionally, the digital token is stored in a mobile wallet. For example, the mobile wallet is implemented as a software application that is stored on a communication device (such as a smartphone, a tablet computer, a laptop computer and so forth) associated with a service provider. Such mobile wallet enables the service provider to receive (and withdraw) the OETs provided to the second autonomous economic agent associated therewith for providing the service and/or to add OETs for obtaining services associated with other second autonomous economic agents, to compensate client autonomous economic agents for failure to provide a service (such as a fine or as part of an insurance claim) and so forth.

The data processing arrangement of the second AEA is operable to generate a smart contract associated with the selected service bid for providing the service. The term ‘smart contract’ as used herein relates to a model or architecture that is intended to facilitate, verify, or enforce the negotiation, specification or performance of an arrangement between the user and the service provider for providing and availing the service. The smart contract includes a plurality of parameters associated with the selected service bid for providing the service. Optionally, the parameters define that the service provided by the service provider relates to the requirements requested by the user. Furthermore, the plurality of parameters associated with the selected service bid includes at least one of a timeframe needed for completion of the service; a cost associated with the service; a quality associated with the service; at least one customised instruction associated with the service. For example, a smart contract may include a parameter defining the service provided to the user; in such an instance, the service may be cleaning a garden area of the user's real estate property. In an example, the smart contract may include a parameter defining the user request, wherein the user may classify a fixed time period within which the user prefers the service to be provided; in such an instance, the user may classify a fixed time period to 09:00 AM to 11:00 AM for cleaning the garden area. In another example, the smart contract may include a parameter, wherein the amount of money to be provided to the service provider for providing the service; in such an instance, the amount of money may be £200 (Pound Sterling) for cleaning the garden area. In yet another example, the smart contract may categorise quality associated with the service; in such an instance, the categorised quality associated with the service may be a high quality. In another example, the smart contract may include customised instruction such as special instruction for performing the service; in such an instance, the smart contract may prefer the service to be an eco-friendly service.

Optionally, the smart contract includes application programing interface (API) that is capable of performing activities such as tracking the interactions between two or more autonomous economic agents. Furthermore, the smart contract is self-performing, self-enforcing, self-fulfilling. Additionally, the interactions between second autonomous economic agent and client autonomous economic agent form the smart contract. For example, a smart contract may include one message communicated within the second autonomous economic agent and client autonomous economic agent.

Optionally, the smart contract includes the parameters for defining the norms for generating nested smart contracts. In an example, the smart contract may define the standards that allow a service provider to collaborate with other service providers to generate a service bid that may be beneficial for the user. Optionally, the smart contract is configured, namely operable, to provide the service provider and the user with the smart contact. Furthermore, the smart contract is configured, namely operable, to control the remuneration that is provided to the service provider for providing the service. Additionally, the smart contract is configured, namely operable, to charge the service provider for not completing the service successfully.

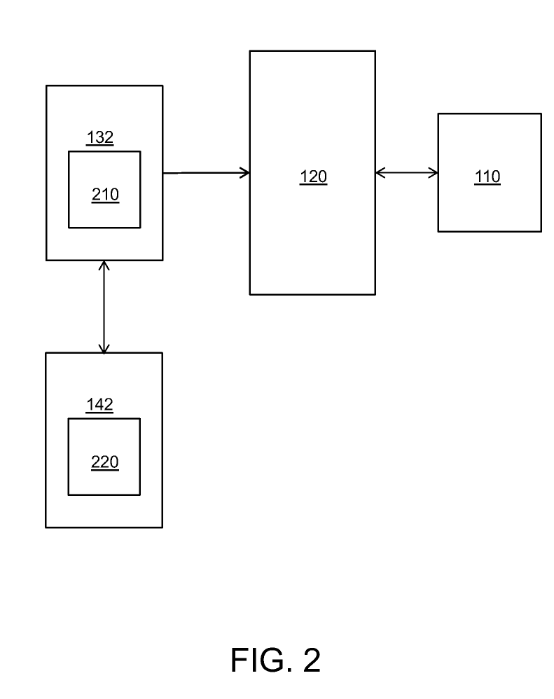

Referring to FIG. 2, there is shown an illustration of an implementation of the system 100 of FIG. 1, in accordance with an embodiment of the present disclosure. As shown the system 100 includes the user equipment 110, the open economic ledger 120, the plurality of service providers 130 (includes 132, 134, 136, 142, 144) associated for providing the service. Furthermore, the service provider 132 includes the service components 210 and the service provider 142 includes the service components 220.

Optionally, the user uses the user equipment 110 to generate a service request for providing a service; for example, the service request may be to survey an area using a drone having specific sensors. The user request is received at the data processing arrangement of the first AEA. The data processing arrangement of the first AEA broadcasts the service request to a plurality of service providers that are registered with the system 100. The service providers provide service bids for the service request. Thereafter, the data processing arrangement of the first AEA analyses the service bids to select at least one service provider 132 including the service components 210. In such an instance, the service provider ‘ABS’ may include the service component such as the drone having a photographic sensor. Furthermore, the service components are registered with the data processing arrangement of the first AEA and the information related to the service component, such as the drone that are associated with the service provider 132, is stored in an OEL 120. Additionally, the service provider 132 and the service component 210 are provided with the mobile wallet. Furthermore, the mobile wallet is configured, namely operable, to store cryptocurrency therein. Additionally, the cryptocurrency are digital tokens (such as “Open Economic Token” or “OET”). Furthermore, the autonomous economic agents of the service providers are configured, namely operable, to transfer and receive digital token for providing the service. Optionally, the service provider may collaborate with another service provider 142 including the service component 220 to complete the service request such as the request for surveying the area using a drone having specific sensors generated by the user. It may be appreciated that the service provider 142 incorporates similar attributes as the service provider 132; for example, the service provider 142 includes a mobile wallet that is configured, namely operable, to store cryptocurrency such as a digital token therein. In such an instance, the service component 220 may be a flight controller system for a drone that is operable to intelligently determine a flight route for the drone with strategic stops for efficient surveillance. In such an example, the service component 220 may provide direction to the service component 210 (drone) for navigation. In such an example, the service provider 132 may transfer a certain amount of digital tokens to the wallet of the service provider 142, for availing the service. Optionally, various components of a drone may belong to various service providers and may include individual autonomous economic agents and may negotiate within themselves and perform financial transaction using a cryptocurrency. In such an instance, a second autonomous economic agent is configured, namely operable, to allow revision of one or more characteristics associated with the generated service request. In one example, the second autonomous economic agent associated with a sensor module of a drone is a selected second autonomous economic agent for a second service request, such as, a service request associated with surveying a location adjacent to the location of aerial inspection by a camera module. In such an instance, the sensor module negotiates with the second autonomous economic agent associated with the mission planning module for revising the flight plan. In such an instance, a portion of remuneration for providing the service by the sensor module is provided to the mission planning module and the camera module respectively. In such an instance, as a higher value is provided for the mission planning module (associated with increase in remuneration), the camera module (associated with increase in remuneration) and the sensor module (that may be required to only compensate for deviation from original flight plan associated with the aerial inspection), the revision is accommodated into the flight plan.

Furthermore, the user is operable to provide a feedback such as a user rating in response to the service provided by the user. Additionally, the user is operable to provide the feedback via the user interface of the user equipment 110 that is being stored in the OML to determine the confidence factor of the service provider. Additionally, a regulatory audit may be performed to determine the quality of the service provided by the service provider and the information generated from the regulatory service may be stored in the OEL 120.

Optionally, the data processing arrangement of the first AEA is configured, namely operable, to analyse a user request to determine the best service bid for the user. Additionally, the data processing arrangement of the first AEA is configured, namely operable, to monitor constantly the execution of the service request by the service providers. In an example, a user may generate a repetitive request of traveling from a source location to a destination. In such an example, the data processing arrangement of the first AEA is operable to determine various parameters of travel from the source to the destination. In such an instance, the parameters may be standard time of travel, the standard cost of travel, fastest route from the source location to the destination. In such an example, the data processing arrangement of the first AEA may analyse the service bid received from the service providers in response to the service request generated by the user and broadcasted by the data processing arrangement of the second AEA, based on the determined parameters. Subsequently, the data processing arrangement of either the first AEA or the second AEA may form a smart contract with a service provider that may be best suited as per the service request generated by the user and the various parameters determined by the data processing arrangement of the first AEA. In such an example, the data processing arrangement of the first AEA may monitor the transportation of the user and identify a delay while the user is in transit. In an event wherein the user is delayed, the data processing arrangement of the first AEA may charge the service provider a penalty (wherein such a penalty may be received in cryptocurrency from the mobile wallet of the service provider) for being unable to complete the service as per the standard norms and rebroadcast the service request for the user to receive a service bid to transport the user from the current location to the destination. Subsequently, service bids from the service providers may be received and a smart contract with the current service provider may be regenerated prior to providing the service provider with the remuneration for the completion of the service. It may be appreciated that the payment of the remuneration may be provided in a form of cryptocurrency. In such an instance, the data processing arrangement of the first AEA may provide to the user information about the new service request being generated on its behalf and to generate a smart contract with the current service provider in the event wherein the user agrees to do so.

In an example, the user may generate a repetitive request at a specific time, such as traveling to a specific location using a specific type of service component, such as electric car (namely, an electrical vehicle) and traveling to a source location from which it traveled to the specific location. In such example, the service provider (such as, an owner) associated with the service component (such as, an electric car, namely an electrical vehicle), may be used for providing other services, such as to serve as a remote battery unit for an electric grid of a electricity supplier using the cars electric battery as a power unit of the electric grid. In such an example, the data processing arrangement of the second AEA may manage the service components of the service provider to provide service to the user. In such an example, the data processing arrangement of the second AEA may suggest the owner of the electric car to provide a partial service to the user (such as transporting the user to the specific location at the specific time requested by the user) and thereafter the data processing arrangement of the first AEA may provide the service provider remuneration in a form of cryptocurrency for providing a partial service to the user. Thereafter the data processing arrangement of the second AEA may outsource the service of transporting the user to the source location and subsequently hire another service provider that provides transportation of persons to the source location via an electric car (namely, an electrical vehicle). In such an example, the data processing arrangement of the second AEA is operable to provide the service provider that transported the user, remuneration in a form of cryptocurrency separately. Furthermore, the data processing arrangement of the second AEA is operable to suggest to the service provider to customise the service component, such as the electric car (namely, electrical vehicle), as per the user's preference, and to turn on an air conditioner after the user is seated inside the car.

In an example, the user may generate a request for sending an item from a location ‘A’ to a location ‘B’. In such an example, the data processing arrangement of the first AEA may broadcast the service request to receive service bids from a plurality of service providers. In such an example, the data processing arrangement of the first AEA may select one or more service providers that may collaborate within themselves to provide the service of transporting the item from the location ‘A’ to location ‘B’. In such an example, the data processing arrangement of the first AEA may generate a smart contract that may dictate the amount of work to be done by each of the service providers. In such an example, the smart contract may dictate that a first service provider transports the item from the location ‘A’ to an intermediate location and thereafter a second service provider receives the item from the first service provider and delivers the item to the location ‘B’. In such an example, the data processing arrangement of the first AEA is configured, namely operable, to provide the service providers that transported the item, remunerations in the form of cryptocurrency separately after the completion of their individual task.

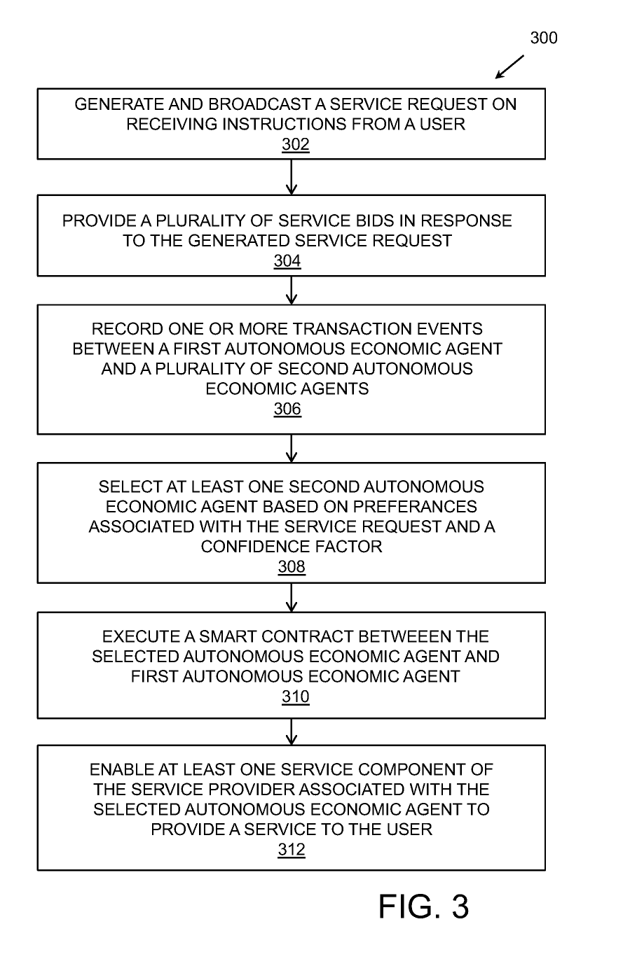

Referring to FIG. 3, there are illustrated steps of a method 300 of providing a service to a user by accessing an open economic framework implemented on a decentralized computing network, in accordance with an embodiment of the present disclosure. At a step 302, a service request is generated and broadcasted by the user. At a step 304, the plurality of second autonomous economic agent provide the plurality of service bids to the first autonomous economic agent in response to the generated service request. At a step 306, the open economic ledger linked to the first autonomous economic agent and the plurality of second autonomous economic agent records one or more transaction events between the first autonomous economic agent and the plurality of second autonomous economic agents. Furthermore, at a step 308, at least one second autonomous economic agent is selected by the first autonomous economic agent based on the preferences associated with the service request and a confidence factor of the least one of the second autonomous economic agent. Moreover, at a step 310, a smart contract between the at least one selected second autonomous economic agent and the first autonomous economic agent is executed for providing the service. Furthermore, at a step 312, the at least one service component of the service provider associated with the selected second autonomous economic agent is enabled to provide the service to the user.

The steps 302 to 312 are only illustrative and other alternatives can also be provided where one or more steps are added, one or more steps are removed, or one or more steps are provided in a different sequence without departing from the scope of the claims herein. For example, in the method the preferences associated with the service request include at least one of: a timeframe is included in the service request for completion of the service; a cost associated with the service; a quality associated with the service; at least one preference associated with the service. Optionally, in the method, at least one service bid of the plurality of service bids is a collaborative service bid associated with two or more autonomous economic agents. Additionally, optionally, in the method, the smart contract includes a plurality of parameters associated with the selected service bid for providing the service. Furthermore, in the method, the plurality of parameters associated with the selected service bid include at least one of a timeframe needed for completion of the service; a cost associated with the service; a quality associated with the service; at least one preference associated with the service. Moreover, in the method, includes the feedback from the user is user rating of the service. Optionally, in the method, the confidence factor is stored in the open economic ledger 120 associated with each of the plurality of service providers. Optionally, in the method, the selected second autonomous economic agent is remunerated by a digital token for the provided service. Furthermore, optionally, in the method, the open economic ledger 120 stores the information associated with the remuneration.

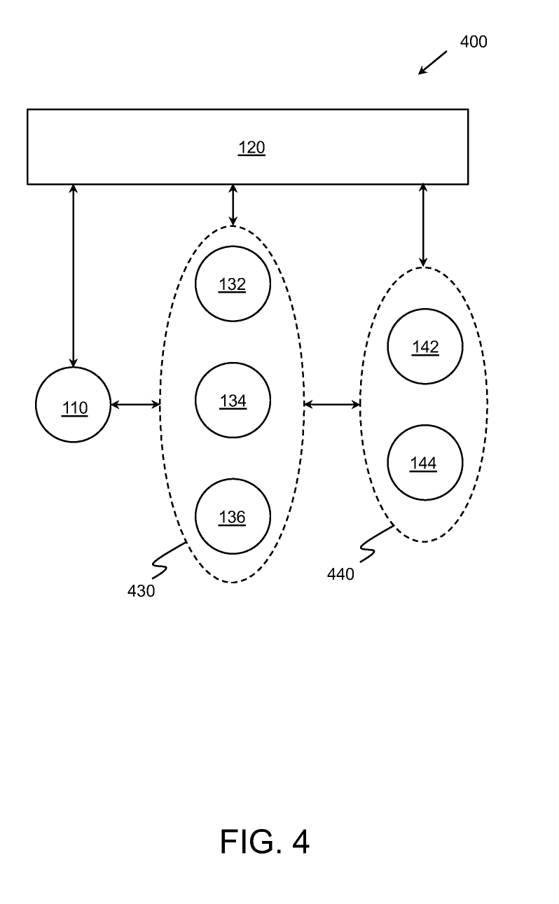

Referring to FIG. 4, there is an illustration of an optional implentation of the open economic framework 400, wherein the plurality of second AEA provide the collaborative bid to the first AEA. Furthermore, the open economic framework of the exemplary implementation, wherein the open economic framework comprises of the first set of second AEA 430, the second set of second AEA 440, the open economic ledger 120 and the user equipment 110. Moreover, the first set of second AEA 430 comprises the plurality of second AEA 132, 134, 136 which operate as the first autonomous economic agent to hire a second set of second AEA 440 (includes 142 and 144) to form the collaborative service bid.

Moreover, the second set of second AEA 440 may operate as the first set of second AEA 430 to further hire other second set of second AEA to form a further collaborative service bid. In an example, let us say that the user instructs the user equipment 110 to generate a service request for hiring a service provider for travelling from place A to place C via place B. However, in a situation where there is no single service provider to provide a service for travelling from place A to place C via place B. So, in such a situation, the second AEA associated with a service provider named alpha, places a collaborative service bid to the first AEA, wherein the collaborative bid comprises of another second AEA associated with the service provider named beta. Furthermore, the service offered by alpha includes transportation service from place A to place B and the service offered by beta includes transportation service from place B to place C. So, the second AEA associated with alpha hires the second AEA associated with beta to provide a collective or collaborative travelling service from place A to C via place B with the help of the service provider beta. Therefore, the second AEA associated with alpha becomes a part of the first set of second AEA and the second AEA associated with beta becomes a part of the second set of second AEA. Now, since the service bid provided to the first AEA is a collaborative service bid so the first AEA does not have to worry about hiring another service for travelling from place B to place C. Once, the collaborative service bid is selected by the first AEA, then the smart contract is generated and executed and consequently after the successful competition of the service the second AEA associated with alpha is remunerated by the first AEA and the second AEA associated with beta is remunerated by the service the second AEA associated with alpha for providing the collaborative service.

Beneficially, such a system for managing services provides the user with optimized management of resources. The system allows for maximizing utilization of resources and maximize value for each of the parties involved, namely the client and the service providers by reducing idle time in a way that a centralized or human mediated system could not. Such a system where service provider AEAs collaborate amongst themselves to provide a collective bid for the request service allows for better utilization of resources for the service providers who are only capable of executing a segment/part of the requested service. Moreover, such a system also increases availability of options for seeking a service by the user as the system is able to take into consideration collective bids wherein multiple service provider autonomous economic agents collectively provide the service to the client. Such a system is especially effective when no single service provider is able to bid in response to the service request generated by the client AEA.

In another example, there is a drone (not shown) comprises of the at least two service components, wherein the two or more service components include at least one of a drone frame, a camera module, a mission planning module, a sensor module, and/or a communication module. Moreover, the service request includes a request to perform aerial photography associated with a location, such as, for aerial inspection. Furthermore, the service request includes one or more parameters, such as a price associated with the service, a time associated with the service, and so forth. In such an instance, the selected second AEA is associated with the camera module. However, the second AEA associated with the camera module will be required to negotiate with another second AEA associated with the drone frame for carrying the camera module to the location. Furthermore, the second AEA associated with the drone frame will be required to negotiate with a second AEA associated with the mission planning module for generating a flight plan for journey of the drone from a current location thereof to the location. Moreover, the second AEA associated with the mission planning module will be required to negotiate with another second AEA associated with an insurance provider (external to the drone, not shown) to obtain an insurance for the flight. In such an instance, the plurality of second AEA associated with various service components of the drone are configured, namely operable, to generate respective service requests and accept service bids generated by the respective second AEA.

Optionally, the first autonomous economic agent and the plurality of second autonomous economic agents encrypts the one or more transaction events by employing intelligent algorithms to secure the open economic framework, wherein the intelligent algorithms include adaptive data encryption and data obfuscation techniques, for example as aforementioned using various combinations of data encryption/decryption, data obfuscation, data padding with decoy redundant data and temporal obfuscation by creating stochastic uncertainty of malicious third-parties when a given communication is communicated within the decentralized computing network; such operation of the intelligent algorithms affect a manner in which the decentralized computing network functions technically. Optionally, the selected second autonomous economic agent receives a feedback from the user, wherein the feedback is used to update the confidence factor of the selected autonomous economic agent on the open economic ledger.

Optionally, the confidence factor includes at least one of: historical information of services provided using the second autonomous economic agent; and number of services provided using the second autonomous economic agent.

Optionally, the plurality of second autonomous economic agents includes a first set of second autonomous economic agents and a second set of second autonomous economic agents, wherein the first set of second autonomous economic agents and the second set of second autonomous economic agents when in operation, generates a collaborative service bid in response to the generated service request.

Optionally, the first set of second autonomous economic agents when in operation, executes at least a portion of the service, and wherein the second set of second autonomous economic agents when in operation, executes the remaining portion of the service.

Optionally, the one or more transaction event corresponds to the exchange of data between the plurality of autonomous, wherein the data includes: the confidence factor of one or more autonomous economic agent; information associated with remuneration; service request; service bid; and smart contract.

Optionally, the preferences associated with the service request include at least one of: a timeframe needed for completion of the service; a cost associated with the service; a quality associated with the service; at least one customised instruction associated with the service.

Optionally, the smart contract includes a plurality of parameters associated with the selected service bid for providing the service.

Optionally, the plurality of parameters associated with the selected service bid includes at least one of a timeframe needed for completion of the service; a cost associated with the service; a quality associated with the service; at least one customised instruction associated with the service.

Optionally, the selected second autonomous economic agent is remunerated by the first autonomous economic agent using an open economic token for the provided service after successful execution of the smart contract.

The method of providing a service to a user of the present disclosure provides an efficient means, namely approach or arrangement, of providing the service. The open economic framework and method provides an easier and simpler mode of acquiring an outsourced service from a service provider. Such method provides a number of service providers to the user to choose from providing increased efficiency for time and money. Moreover, the increased alternatives for the user creates a competitive edge among the service providers, and hence, improving the quality of service provided to the user. The availability of past record of services provided by the service provider enables the user to critically view the service provider's commitment towards the job at hand. Furthermore, the quality of past services of the service provider ensures credibility to the user. Additionally, the user gets assured regarding the task assigned to the service provider. Consequently, the present disclosure enables the user to receive a satisfactory service at preferred location and time without spending a lot of time and extra money.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A system that provides, when in operation, services autonomously via an open economic framework (OEF) implemented on a decentralized computing network, characterised in that the system comprises:
a first autonomous economic agent associated with a user equipment coupled to the computing network that generates and broadcasts, when in operation, a service request, wherein the first autonomous economic agent receives instruction for generating the service request from a user using the user equipment;
a plurality of second autonomous economic agents hosted within the open economic framework associated with a plurality of service providers, wherein each of the service providers comprises at least one service component, wherein the plurality of second autonomous economic agents provides, when in operation, the first autonomous economic agent with a plurality of service bids via the open economic framework in response to the generated service request; and
an open economic ledger linked to the first autonomous economic agent and the plurality of second autonomous economic agents, wherein the open economic ledger when in operation, records one or more transaction events between the first autonomous economic agent and the plurality of second autonomous economic agents,
wherein the first autonomous economic agent when in operation, selects at least one of the second autonomous economic agents based on the preferences associated with the service request and a confidence factor of the least one of the second autonomous economic agents, and wherein the at least one selected second autonomous economic agent when in operation, performs an execution of a smart contract with the first autonomous economic agent for providing the service autonomously, and wherein the execution of the smart contract is subject to a degree of data protection implemented via the decentralized computing network that is adaptively adjusted depending upon one or more parameters of the smart contract.

2. A system of claim 1, wherein, when implementing the degree of data protection, the first autonomous economic agent and the plurality of second autonomous economic agents encrypt the one or more transaction events by employing intelligent algorithms to secure the open economic framework, wherein the intelligent algorithms include adaptive data encryption and data obfuscation processing operations.

3. A system of claim 2, wherein, when the decentralized computing network is in operation, the adaptive data encryption and data obfuscation processing operations are selected depending upon at least one of: a temporal rate of execution of smart contracts via a given node of the decentralized computing network, considerations associated with smart contracts being executed via a given node of the decentralized computing network.

4. A system of claim 3, wherein the adaptive data encryption and data obfuscation processing operations employ a combination of following data protection processes: encryption, decryption, data obfuscation by swapping one or more bits of data bytes, addition of obfuscating redundant data (“data decoys”), temporally randomized transmission times for data within the decentralized computing network.

5. A system of claim 1, wherein the selected second autonomous economic agent receives a feedback of the service performed, wherein the feedback is used to update the confidence factor of the selected autonomous economic agent on the open economic ledger.

6. A system of claim 5, wherein the confidence factor is updated based on:
historical information of services provided by the second autonomous economic agent; and
number of services provided by the second autonomous economic agent.

7. A system of claim 1, wherein the plurality of second autonomous economic agents includes a first set of second autonomous economic agents and a second set of second autonomous economic agents, wherein the first set of second autonomous economic agents and the second set of second autonomous economic agents when in operation, generates a collaborative service bid in response to the generated service request.

8. A system of claim 7, wherein the first set of second autonomous economic agents when in operation, executes at least a portion of the service, and wherein the second set of second autonomous economic agents when in operation, executes the remaining portion of the service.

9. A system of claim 1, wherein the one or more transaction event corresponds to the exchange of data between the plurality of autonomous agents, wherein the data includes the confidence factor of one or more autonomous economic agent, information associated with remuneration, service request, service bids.

10. A system of claim 9, wherein the smart contract includes a plurality of parameters associated with the selected service bid for providing the service, wherein the plurality of parameters associated with the selected service bid include at least one of a timeframe needed for completion of the service, a cost associated with the service, a quality associated with the service, at least one customised instruction associated with the service.

11. A method for (of) providing services autonomously using an open economic framework implemented on a decentralized computing network, characterised in that the method comprises:
generating and broadcasting a service request upon receiving instruction for generating the service request from a user, wherein a user equipment is coupled to the computing network for generating and broadcasting the service request when in operation,
providing a plurality of service bids by a plurality of second autonomous economic agents in response to the generated service request via the open economic framework, wherein the plurality of second autonomous economic agents is hosted within the open economic framework
recording one or more transaction events between the first autonomous economic agent and the plurality of second autonomous economic agents,
selecting at least one of second autonomous economic agent based on preferences associated with the service request and a confidence factor associated with the plurality of the second autonomous economic agents, wherein the confidence factor is acquired by the first autonomous economic agent from the open economic ledger, wherein the plurality of second autonomous economic agents associated with a plurality of service providers, wherein each of the service providers comprise at least one service component,
performing an execution of a smart contract between the at least one selected second autonomous economic agent and the first autonomous economic agent, wherein the execution of the smart contract is subject to a degree of data protection implemented via the decentralized computing network that is adaptively adjusted depending upon one or more parameters of the smart contract, and
enabling at least one service component of the service provider associated with the selected second autonomous economic agent to provide the service to the user.

12. A method of claim 11, wherein, when implementing the degree of data protection, the first autonomous economic agent and the plurality of second autonomous economic agents encrypt the one or more transaction events by employing intelligent algorithms to secure the open economic framework, wherein the intelligent algorithms include adaptive data encryption and data obfuscation processing operations.

13. A method of claim 12, wherein, when the decentralized computing network is in operation, the adaptive data encryption and data obfuscation processing operations are selected depending upon at least one of: a temporal rate of execution of smart contracts via a given node of the decentralized computing network, considerations associated with smart contracts being executed via a given node of the decentralized computing network.

14. A method of claim 13, wherein the adaptive data encryption and data obfuscation processing operations employ a combination of following data protection processes: encryption, decryption, data obfuscation by swapping one or more bits of data bytes, addition of obfuscating redundant data (“data decoys”), temporally randomized transmission times for data within the decentralized computing network.

15. A method of claim 14, wherein the method comprise receiving user feedback based on the services performed, and updating the confidence factor of the selected autonomous economic agent on the open economic ledger.

16. A method of claim 11, wherein the confidence factor is updated based on:
historical information of services provided using the second autonomous economic agent; and
number of services provided using the second autonomous economic agent.

17. A method of claim 11, wherein the plurality of second autonomous economic agents includes a first set of second autonomous economic agents and a second set of second autonomous economic agents, wherein the first set of second autonomous economic agents and the second set of second autonomous economic agents when in operation, generates a collaborative service bid in response to the generated service request.

18. A method of claim 11, wherein the first set of second autonomous economic agents when in operation, executes at least a portion of the service, and wherein the second set of second autonomous economic agents when in operation, executes the remaining portion of the service.

19. A method of claim 11, wherein the one or more transaction event corresponds to the exchange of data between the plurality of autonomous, wherein the data includes the confidence factor of one or more autonomous economic agent, information associated with remuneration, service request, service bid.

20. A computer program product for providing services autonomously using an open economic framework implemented on a decentralized computing network, the computer program product comprising a non-transitory machine-readable data storage medium having stored thereon program instructions that, when accessed by a processing device, cause the processing device to:
generate and broadcast a service request upon receiving instruction for generating the service request from a user, wherein a user equipment is coupled to the computing network for generating and broadcasting the service request when in operation,
provide a plurality of service bids by a plurality of second autonomous economic agents in response to the generated service request via the open economic framework, wherein the plurality of second autonomous economic agents is hosted within the open economic framework
record one or more transaction events between the first autonomous economic agent and the plurality of second autonomous economic agents,
select at least one of second autonomous economic agent based on preferences associated with the service request and a confidence factor associated with the plurality of the second autonomous economic agents, wherein the confidence factor is acquired by the first autonomous economic agent from the open economic ledger, wherein the plurality of second autonomous economic agents associated with a plurality of service providers, wherein each of the service providers comprise at least one service component,
perform an execution of a smart contract between the at least one selected second autonomous economic agent and the first autonomous economic agent, wherein the execution of the smart contract is subject to a degree of data protection implemented via the decentralized computing network that is adaptively adjusted depending upon one or more parameters of the smart contract, and
enable at least one service component of the service provider associated with the selected second autonomous economic agent to provide the service to the user.
